(19) United States
(12) Patent Application Publication
(10) Pub. No.: US 2012/0048080 A1
(43) Pub. Date: Mar. 1, 2012

(54) DEVICE FOR TREATING A MEDICAL SAC AND RELATIVE METHOD

(75) Inventor: Fabio Zardini, Castelfranco Veneto (IT)

(73) Assignee: STEELCO SPA, Riese Pio X (IT)

(21) Appl. No.: 13/318,777

(22) PCT Filed: May 5, 2010
(86) PCT No.: PCT/IB2010/001031

§ 371 Date: Nov. 3, 2011

(30) Foreign Application Priority Data
May 6, 2009 (IT) UD2009A000088

(51) Int. Cl. B65B 69/00; B26D 5/02; B26D 7/27

(52) U.S. Cl. 83/13; 83/554; 83/168

(57) ABSTRACT

A device for treating at least a medical sac and relative method, including at least a containing element, inside which the medical sac is accommodated according to a main positioning axis, and a cutting unit, containing at least a cutting element associated with movement elements to open the sac with the purpose of allowing the sac to be emptied and/or subsequently washed and/or disinfected. The movement elements are able to move, in sequence, the cutting unit in a first direction approaching the sac, substantially perpendicular to the main positioning axis of the sac, and in a second direction, substantially parallel to the main positioning axis of the sac, after having at least contacted and/or holed the sac with the cutting element during the first movement in order to effect the cutting action on the sac.

### FIELD OF THE INVENTION

The present invention concerns a device for the treatment, that is, opening, emptying and washing and disinfecting a medical sac, that is, a sac of the type used in the hospital, health-care, nursing/assistance sector to contain a biological liquid or body fluid, such as blood, plasma or urine, or of the type used to drain fluids. The invention also concerns the method which uses this device. In particular, with the present invention it is possible to effect the automatic opening of the sac, to make the liquid contained therein flow out, the subsequent washing and the possible disinfection thereof so as to be able to dispose of the sac thus treated as normal waste.

### BACKGROUND OF THE INVENTION

The use of a multiplicity of different sacs is known in the hospital, health-care or nursing/assistance sector to store, transport and distribute various biological liquids and body fluids, typically made of plastic, more or less rigid or flexible.

Urine sacs to collect urine from a patient, blood sacs used for example in the blood transfusion sector to store and distribute the blood to patients and sacs used for the drainage of fluids are all known. Typically these types of sac are disposable and must be eliminated as waste after being used only once. Since, when they are eliminated, they usually contain the aforesaid biological liquids or body fluids, or remains thereof, often contaminated with virus or bacteria, the sacs have to be considered a high-risk contamination material for the operators, that is, they constitute special waste, which requires special methods for its disposal, with higher costs and time with respect to the disposal of normal waste.

A large number of devices to treat these sacs are known, especially for urine sacs, with the purpose of emptying and disinfecting them, so that, after the treatment, they can be considered uncontaminated and therefore can be disposed of as normal waste.

For instance, documents U.S. Pat. No. 3,809,577, U.S. Pat. No. 5,190,429, EP-A-1.010.623 and WO-A-83/02722 describe devices with a washing chamber, in which a urine sac is placed, with its aperture facing upward, in a rack. A cutting element of the scissor type is used to make a hole in the bottom of the sac, so the urine can come out. Subsequently, the sac is disinfected by means of a plurality of nozzles provided inside the chamber. This solution, however, does not guarantee a reliable washing and disinfection of the inside of the sac, in that the aperture obtained, even if it allows to drain the fluid, does not create a sufficient passage for the washing and/or disinfectant fluid.

A device is also known from document WO-A-2004/028907 to disinfect a sac containing a body fluid which provides a horizontal support grid having shaped surfaces inclined toward the center, in which the sac is placed, a knife to cut the sac in correspondence with the central zone of the grid from the lower side thereof, and injection means to inject a washing and disinfecting fluid, conformed to be inserted in the sac itself.

However, even this known solution does not guarantee that, when the aperture of the sac is opened to drain the fluid, a passage wide enough to allow a uniform spread of the washing/disinfecting fluid inside the sac is created. Actually, for some types of sacs that are particularly soft and flexible, even of limited size, the knife may not act efficiently on the sac. Moreover, other types of sacs, such as for example those that hold blood, which tend to be particularly flat and rigid, are particularly difficult to position in a stable way on the surfaces of the grid, shaped and inclined toward the center, because their shape is not easily adaptable and consequently, cutting the sac may be difficult and inefficient.

Documents DE-C-19946140 and DE-C-19946141 are also known: they show a device of the type under discussion in which, in the washing chamber, a rotating containing element is provided inside which the sac is located and which has a plurality of passage windows. A battery of cutting tools, mounted fixed on a fixed pin, in correspondence with a relative window of the containing element, selectively cooperates with the aforesaid containing element, when this turns, and penetrates the window, causing the sac to be opened. This known device also has disadvantages in the cutting of the sac, particularly for sacs of a soft and flexible consistency, because sometimes the sac, instead of being cut, is deformed and winds around the cutting tool, causing the device to malfunction.

Another device for cutting sacs is known from document NL8500915, even if it is not intended for cutting medical sacs.

One purpose of the present invention is to achieve a device for treating, that is, opening, emptying and washing/disinfecting at least a sac containing a biological liquid, which determines an adequate opening of the sac in order to effect a reliable disinfection thereof, including inside it. Specifically, one purpose of the present invention is to guarantee a high efficiency of the cutting of the sac, both for sacs which are of a soft consistency and for those which are rigid, and for sacs of a particular shape, such as flat sacs.

Another purpose of the present invention is to prevent the sacs from interfering in an unsuitable manner with the cutting elements intended to open them, and therefore without winding around them or avoiding the cutting action.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, a device according to the present invention is used for the treatment of at least a medical sac, that is, a sac able to contain, or to drain, a body fluid or a biological liquid. The device comprises at least a containing element, inside which the medical sac is accommodated according to a main positioning axis, and a cutting unit, comprising at least a cutting element, associated with movement means in order to open the sac, with the purpose of allowing it to be emptied.

According to one feature of the present invention, the movement means are able to move, in sequence, the cutting unit in a first direction approaching the sac, substantially perpendicular to the main positioning axis of said sac, and in a second direction substantially parallel to said main positioning axis of the sac, after having at least contacted it and/or holed it during the first movement, in order to effect the cutting action on the sac. By the term substantially perpendicular we mean a direction that, in relation to the reciprocal positioning of the cutting element and the relative movement mean, determines a substantially perpendicular impact between the cutting element and the wall of the sac. The movement of the cutting unit in a direction substantially perpendicular to the main positioning axis of the sac allows the at least one cutting element of the cutting unit to approach the medical sac, until it holes it by direct contact. The movement in a substantially perpendicular direction stops when the at least one cutting element reaches the desired insertion level inside the sac. Once the movement in a perpendicular direction stops, the movement of the cutting element is activated in a direction parallel to the main positioning axis of the sac. The cutting element slides along the surface of the sac and is able to make an aperture, to an adjustable extent but possibly also completely, in the sac in the direction of the main positioning axis, and therefore to open it completely, or in any case enough to make the subsequent treatment possible.

The sequential combination of the two movements of the cutting unit prevents the sac from avoiding the cutting action or from winding around the cutting element, and guarantees that the aperture made is wide enough to allow a substantially complete emptying of the sac and its subsequent effective and reliable washing and disinfection.

According to the present invention, the device also comprises a pressure unit, able to achieve a thrust against the medical sac in an opposite direction to that in which the cutting unit approaches.

According to one feature of the present invention, the pressure unit comprises at least a pressure element having at least an operating position in direct contact with the sac during the cutting operation, and an inactive position distanced from it, during the steps prior to and after the cutting, for example for loading the sacs to be treated.

The device can also comprise delivery means to deliver a washing and/or disinfecting fluid toward the sac.

According to a variant of the present invention, the movement means comprise a first movement unit able to move the cutting unit in the direction of approach, substantially perpendicular to the positioning axis of the sac, and a second movement unit, distinct from the first, able to move the cutting unit in a direction substantially parallel to the main positioning axis, in order to make the cut, keeping the first movement unit substantially still.

According to another variant of the present invention, the first movement unit comprises a slider sliding on guides.

According to another variant, the second movement unit comprises a transmission belt, rotating around at least two pulleys mounted on said slider, on which belt the cutting unit is fixed, so as to move along the sac to be treated.

According to another variant of the present invention, the first movement unit comprises its own drive member able to move the slider along the guides in a direction substantially perpendicular to the main positioning axis, while the second movement unit comprises its own drive member, distinct and independent from the previous one, in order to move the cutting unit in a direction substantially parallel to the main positioning axis of the sac.

According to a further variant, in which the containing element comprises a lid to open/close it, the aforesaid pressure element comprises a movement element, for example a lever, connected at one free end to the lid by a hinging element in order to coordinate the movements of the pressure element attached thereto with the movements of the lid. In this way, the opening of the lid corresponds to a positioning of the pressure element distanced from the sac, whereas the closure of the lid corresponds to an approach of the pressure element in contact with the sac in a position predisposed for cutting, which assumes an inactive position.

According to another variant, the at least one pressure element is a comb. This particular configuration allows an efficient effect of contrasting the cutting, in that the cutting element of the cutting unit is inserted between two successive elements of the comb and cuts the surface of the medical sac which is interposed between the two elements.

Another feature of the present invention concerns the method of cutting at least a medical sac by means of a device for the treatment of at least a medical sac, comprising at least a containing element, inside which the medical sac is accommodated according to a main positioning axis, and a cutting unit associated with movement means in order to open the sac with the purpose of allowing it to be emptied. The method of the present invention comprises a movement, in sequence, of said cutting unit in a first direction approaching the sac, substantially perpendicular to the main positioning axis of the sac, and in a second direction substantially parallel to the main positioning axis of the sac, after having at least contacted and/or holed it during the first movement, in order to effect the cutting action of the sac. The method of the present invention also provides the coordinated drive of a pressure element by means of a relative movement element in order to achieve a thrust against the medical sac in the direction opposite the one in which the cutting unit approaches.

### BRIEF DESCRIPTION OF THE DRAWINGS

These and other characteristics of the present invention will become apparent from the following description of a preferential form of embodiment, given as a non-restrictive example with reference to the attached drawings wherein:

FIGS. 1a, 1b, 1c and 1d are front views of a device for the treatment of a medical sac, in different steps of the treatment method.

FIG. 2 is a partial view from above of the device for the treatment of a medical sac in FIGS. 1a-1d.

FIG. 3 is a lateral view of the device for the treatment of at least one medical sac in FIGS. 1a-1d.

FIGS. 4a and 4b are two lateral views of a detail of the device in FIGS. 1a-1d in two different steps of the treatment method.

### DETAILED DESCRIPTION OF A PREFERENTIAL FORM OF EMBODIMENT

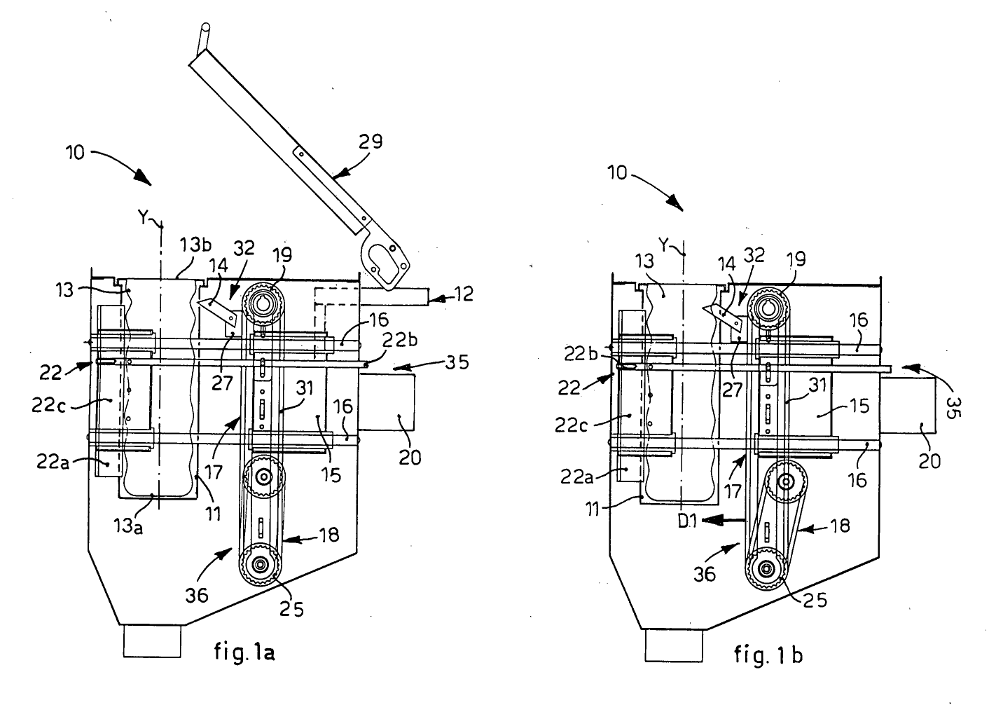

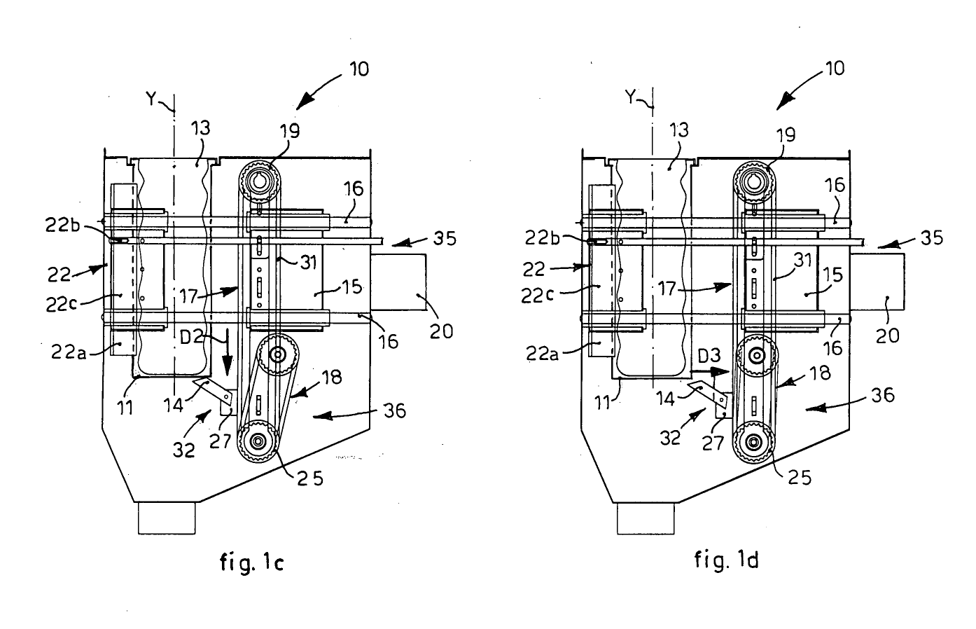

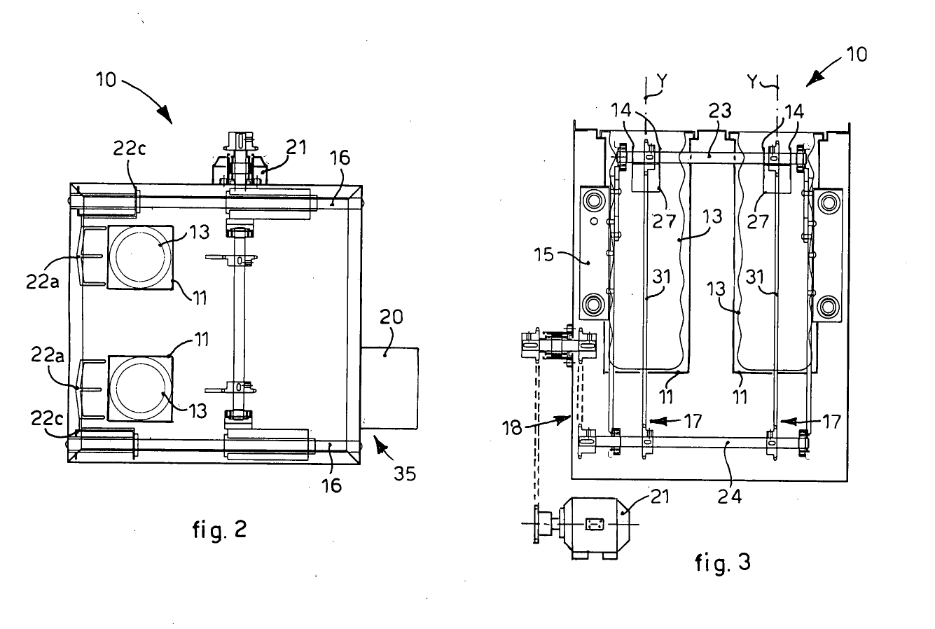

With reference to FIG. 1a, a device 10 according to the present invention is applied in order to treat at least one medical sac 13, in this case two, and comprises a containing element 11, inside which two medical sacs 13 are accommodated (FIGS. 2 and 3).

In particular, each medical sac 13 is positioned according to a relative main positioning axis “Y”.

The device 10 also comprises a cutting unit 32 comprising two support blocks 27 and one or more cutting elements 14. In this case, for each support block two cutting elements 14 are provided (FIG. 3).

However, it is not to be excluded that is other forms of embodiment of the device 10 according to the present invention, for each support block 27 the cutting elements 14 are provided singly, in threes or groups of four or more, depending on the particular functional and operating conditions expected.

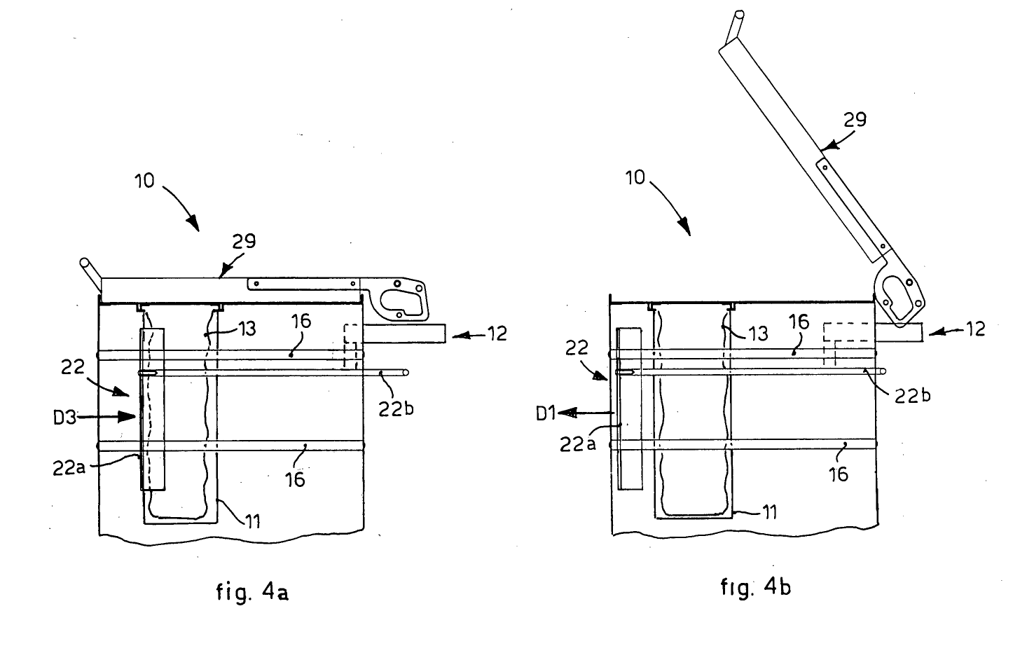

The containing element 11 comprises a lid 29, shown in FIGS. 1a, 4a and 4b to allow the insertion and positioning of the medical sacs 13, and to prevent contamination of the environment during the treatment. The device 10 also comprises two movement units, 35 and 36, to move the cutting unit 32 in order to exert a cutting action on the medical sacs 13. The movement of the cutting unit 32 occurs in sequence, in a first direction D1 approaching the sacs 13, substantially perpendicular to the main positioning axis “Y” of the sacs 13, and in a second direction D2, substantially parallel to said axis “Y” of the sacs 13 after having at least contacted them and/or holed them with the cutting elements 14 during the first movement in direction D1, to effect the cutting of the sacs 13. The position assumed by the cutting elements 14 at the end of the approach movement in direction D1 is shown in FIG. 1b, where the cutting elements 14 are partially inserted inside the medical sacs 13, which are then holed by them. The subsequent movement of the cutting unit 32 in direction D2 substantially parallel to the main positioning axis “Y” of the sac 13 causes the cutting elements 14 to open the sacs 13, and the position of the cutting elements 14 at the end of this movement is shown in FIG. 1c, where the cutting elements 14 are not in contact with the sacs 13, but are near their exit end 13a. The sacs 13 have therefore been completely opened on one side, so that the liquid contained therein is completely emptied out and it is possible to proceed to the washing and disinfection operations.

The drawings 1a and 1d show two further positions of the cutting unit 32, both non-operative, in which the cutting elements 14 are not in contact with the sacs 13 and are positioned, respectively, with the cutting elements 14 in proximity to the entrance end 13b of the sacs 13 and in proximity to their exit ends 13a. In at least one of the two non-operative positions, in particular that shown in FIG. 1d, the cutting element 14 is located in a zone of the device 10 not immediately accessible to the operator, in order to guarantee the safety and security of the operator when the operations to insert and withdraw the sacs 13 are being carried out.

The first movement unit 35, effecting the first approach movement in direction D1, comprises a slider 15 sliding on guides 16, having an axis substantially perpendicular to the positioning axis “Y” of the sacs 13, which is driven by a first drive member 20. The second movement unit 36, effecting the movement in direction D2 parallel to the positioning axis “Y” of the sacs 13, comprises a transmission belt 17 for each sac 13, driven by a second drive member 21 by means of a reduction unit 18. The transmission belt 17 comprises a chain 31 in a closed configuration around two pulleys 19 and 25 made to rotate by two shafts 23 and 24, parallel to each other and shown in FIG. 3, mounted on the slider 15 so as not to constrain the rotation thereof. Consequently, the belt 17 is subjected to the approach movement D1 effected by the slider 15, with which it is solid, and to the rotation movement of the pulleys 19 and 25, imparted by the second drive member 21, which causes the chain 31 to move. The cutting elements 14 are mounted on the chain 31 by means of the support block 27. As shown in FIG. 3, representing a device 10 with two sacs 13, two cutting elements 14, with relative block 27, are associated with each sac 13. Moreover, a relative second movement unit 36 is associated with each sac 13, with a relative transmission belt 17 disposed centrally with respect to the sac 13 and distanced from it, located parallel to the main positioning axis “Y” of the respective sac 13. There is only one slider 15, on the other hand, and the rotating shafts 23 and 24 are attached to it in order to move the relative belts 17, the shafts 23 and 24 are moved in the direction D1 perpendicular to the positioning axis “Y” of the sacs 13 when the first movement unit is driven.

FIG. 2 shows that a pressure unit 22 is associated with each sac 13, comprising a pressure element 22a fixed to a slider 22c sliding on the same guides 16 as the slider 15. The pressure element 22a has a comb configuration, able to achieve, in an operating step, a contrasting thrust against the medical sac 13 in a direction D3 in an opposite direction to the approach direction D1 of the cutting unit 32, as shown in FIG. 4a. The pressure element 22a is also able to achieve, in an inactive step, a distancing movement in the same direction D1 as the cutting unit 32, until it reaches an inactive position, not in contact with the sac 13, shown in FIG. 4b. The pressure unit 22 also comprises a movement element 22b, for example a lever, connected at one of its free ends to the lid 29 by a hinging element 12 in order to coordinate the movements of the pressure element 22a, solid therewith, with those of the lid 29. The lid 29 pushes the movement element 22b as it opens and pulls it as it closes, and consequently does the same to the pressure element 22a, which slides along the sliding guides 16 of the slider 22c, to which it is attached. As shown in FIGS. 4b and 4a, respectively, as the lid 29 opens, the pressure element 22a is taken into its inactive position distanced from the sac 13, and as the lid 29 closes, the pressure element 22a is taken into the operating position in contact with the sac 13. In this way, when the lid 29 is open, the pressure element 22a is distanced from the sac 13, so that all the operations needed for the removal of the treated sac 13 and/or the loading of a new sac 13 to be treated can be easily effected. When the lid 29 is closed, the pressure element 22a moves automatically into the operating position in contact with the sac 13 on the opposite side with respect to that where the cutting unit 32 is, so that the treatment cycle can be started in safety.

It is clear that modifications and/or additions of parts may be made to the device 10 for the treatment of medical sacs and the cutting method as described heretofore, without departing from the field and scope of the present invention.

It is also clear that, although the present invention has been described with reference to some specific examples, a person of skill in the art shall certainly be able to achieve many other equivalent forms of device, having the characteristics as set forth in the claims and hence all coming within the field of protection defined thereby.

1. A device for treating at least a medical sac, comprising
at least a containing element, inside which the medical sac is accommodated according to a main positioning axis, and
a cutting unit, comprising at least a cutting element associated with movement means to open the sac with the purpose of allowing the sac to be emptied and/or subsequently washed and/or disinfected,
wherein said movement means are able to move, in sequence, said cutting unit in a first direction approaching the sac, substantially perpendicular to the main positioning axis of said sac, and in a second direction (D2), substantially parallel to said main positioning axis of the sac, after having at least contacted and/or holed the sac with said cutting element during the first movement to effect the cutting action on the sac,
said device also comprising a pressure unit, able to achieve a contrasting thrust against the medical sac on the side opposite the one where the cutting unit acts, and
wherein said pressure unit comprises at least a pressure element, associated with each sac and having at least an operating position in direct contact with the sac during the cutting operation in which the pressure element exerts a thrust against the relative sac in a third opposite direction to the first direction in which the cutting unit approaches, and an inactive position distanced from the sac with a movement in the same first direction as the cutting unit during the steps preceding and subsequent to the cutting.

2. The device as in claim 1, wherein said movement means comprise a first movement unit able to move said cutting unit in the approach first direction substantially orthogonal to the positioning axis of the sac, and a second movement unit, distinct from the first, able to move said cutting unit in the second direction substantially parallel to the main positioning axis of the sac, to effect the cut, keeping the first movement unit substantially stationary.

3. The device as in claim 2, wherein the first movement unit comprises a slider sliding on guides.

4. The device as in claim 2, wherein the second movement unit comprises a transmission belt, rotating around at least two pulleys mounted on said slider, on which belt said cutting unit is fixed, so as to move along the sac to be treated.

5. The device as in, claim 3, wherein said first movement unit comprises its own drive member able to move the slider along the guides in the first direction substantially perpendicular to said main positioning axis of the sac, while said second movement unit comprises its own drive member, distinct and independent from the first movement unit drive member, to move the cutting unit in the second direction substantially parallel to the main positioning axis (“Y”) of the sac.

6. The device as in claim 1, wherein the containing element comprises a lid to open/close the containing element, and wherein said pressure element comprises a movement element connected, at one free end, to said lid by a hinging unit to coordinate the movements of the pressure element attached thereto with the movements of the lid.

7. The device as in claim 1, wherein said pressure element has a comb configuration.

8. The device as in claim 1, comprising delivery means to deliver a washing and/or disinfecting fluid to the sac.

9. A method for cutting at least a medical sac by means of a device for treating at least a medical sac, comprising at least a containing element, inside which the medical sac is accommodated according to a main positioning axis, and a cutting unit associated with movement means to open the sac, with the purpose of allowing the sac to be emptied, the method comprising:
a first movement, in sequence, of said cutting unit in a first direction approaching the sac, substantially perpendicular to said main positioning axis of the sac, and in a second direction, substantially parallel to said main positioning axis (“Y”) of the sac, after having at least contacted and/or holed the sac during the first movement, to effect the cutting action on the sac, and coordinated driving of a pressure element, associated to each sac, by means of a relative movement element to achieve a thrust against the medical sac in a third opposite direction to the approach first direction of the cutting unit.
